(19) United States
(12) Patent Application Publication
(10) Pub. No.: US 2024/0083114 A1
(43) Pub. Date: Mar. 14, 2024

(54) PATTERNING DEVICE FOR THE PREPARATION OF THREE-DIMENSIONAL STRUCTURES AND METHOD FOR THE PRODUCTION THEREOF

(71) Applicant: AO Technology AG, Chur (CH)

(72) Inventors: Tiziano SERRA, Davos Platz (CH); Marc THURNER, Wavre (CH)

(21) Appl. No.: 17/768,393

(22) PCT Filed: Oct. 14, 2020
(86) PCT No.: PCT/IB2020/059621

§ 371 Date: Apr. 12, 2022

(30) Foreign Application Priority Data
Oct. 15, 2019 (EP) EP19203370.2

(51) Int. Cl. B29C 64/307; B29C 64/165

(52) U.S. Cl. CPC B29C 64/307; B29C 64/165; B33Y 10/00

(57) ABSTRACT

The invention presents a patterning device (1) for the preparation of three-dimensional structures of a sample (S) comprising particles (P) free to migrate in a matrix (M). The device comprises a pattern generator (3) and a holder (2) connected to the pattern generator (3) on which is placed a sample (S). The patterning device (1) further comprises at least one transformation device (D) adapted for the transformation of the matrix (M) into a modified matrix (A/P) wherein the particles (P) are no longer free to migrate. The invention is also directed to a process for the production of a three-dimensional structure.

### FIELD OF THE INVENTION

The present invention concerns an integrated device for the preparation of three-dimensional structures, and in particular three-dimensional structures of biological material, such as artificial biological tissues. The preparation of such three-dimensional structures is based on Faraday waves (FW), which can be combined with additive manufacturing techniques. In particular, the present patterning device allows an easy and convenient production of functional biological tissues by triggering self-assembly processes. Such an integrated device thus comprises one or more pattern generators and can, additionally, comprise one or more additive manufacturing elements.

### DESCRIPTION OF RELATED ART

Processes based on Faraday waves (FW) are already known for generating artificial biological tissues. A method using such approach is for example described in the patent application WO2019038453. In this case, specific patterns are generated in a layer of particles spread in a hydrogel matrix, using sound vibrations. It is necessary to combine several layers to obtain a three-dimensional structure, while properly maintaining the particles in the matrix.

Other limitations of the currently used techniques relate to the reduced diversity of the material which can be used to provide the artificial biological tissues and the complexity of the produced biomaterial.

The devices used for the application of the known processes are not adapted for the production of three-dimensional structures in a highly reproducible manner. In particular, various devices are separately used and handled, which is a source of variation in the samples produced therewith and limitations in terms of number and diversity of three-dimensional structures which can be produced.

The known methods, which are lengthy and costly, are furthermore not adapted for the production of three-dimensional structures at a point of care.

It appears thus necessary to improve the processes currently applied, as well as the devices used for the production of three-dimensional structures.

### BRIEF SUMMARY OF THE INVENTION

It is an object of the present invention to propose a patterning device allowing the preparation of three-dimensional structures of a material in a fast, straightforward and highly reproducible manner. Such material denotes any particles suspended in a matrix in such a way to be able to migrate in the matrix under sound wave or other vibrational waves constraints, together with the matrix itself, the properties of which can be modified. In particular, the viscosity or the rheological properties, and any other physical and chemical properties of the matrix can be modified from a state where the particles immersed in the matrix are free to migrate under exposure to vibrational waves to a state where the particles are immobilized in the matrix. The particles thus generate a pattern in the matrix, which is adapted for the production of a three-dimensional structure.

In the present disclosure, the term “pattern” denotes a non-homogenous arrangement of the particles under the influence of vibrational waves. In particular the pattern may reflect the shape of the waves within the matrix, defined by the concentration of the particles in the matrix. The pattern thus defines gradient concentrations having local maxima and minima. In other word the “pattern” object of the present disclosure excludes any homogenous spread of the particles. It can relate to a geometrical arrangement, comprising periodical or regular variation of concentration. Alternatively, the pattern can relate to non-geometrical arrangements.

The particles referred to denote any particles which can be suspended in a matrix and are able to migrate under exposure to vibrational waves. More particularly, the particles can be of organic, inorganic or metallic type. Such inorganic particles include tricalcium phosphate, hydroxyapatite, other calcium phosphates, calcium sulphate, magnesium carbonate, calcium carbonate and any inorganic salts or complexes. Organic particles include any organic compound or group of compounds such as organic oligomers or organic polymers, fatty acids, liposomes, and encapsulated organic compounds. Organic particles also includes potential active molecules such as drugs or combination of drugs. Organic particles also refers to biological particles, in the sense of living material, such as cells, cell agglomerates, tissue fragments, organoids, spheroids, bacteria, microsomes, and components of living material such as proteins, microparticles loaded with proteins or signaling molecules, as well as any peptide, polypeptide, nucleic acid oligomers and nutritive elements for biological cells. The biological cells can be of any type, including osteoblasts, fibroblasts, keratinocytes, human mesenchymal stem cells, chondrocytes, or human umbilical vein endothelial cells, or a mixture thereof. It is to be understood that particles can include mixtures of organic component, inorganic components, metallic components and living material.

The matrix denotes any material adapted for suspending particles such as hydrogel, paste, fluid and any other material. The matrix may comprise gelatin or gelatin derivatives such as gelatin methacrylate, hyaluronic acid or hyaluronic acid derivatives such as hyaluronic acid methacrylate, or collagen, fibrin/thrombin, matrigel, atrigel, agarose, hyaluronan tyramine, alginate or a mixture thereof. The matrix further comprises components or mixtures of components adapted for modifying the physical properties of the matrix, at least adapted for increasing the viscosity to prevent the migration of the particles in the matrix once it has been modified.

It is understood that the particles themselves are preferably not subject to polymerization or reticulation under the process of the present disclosure. The particles thus remain non linked and non-combined to each other. The matrix comprising the particles is on the contrary subject to some modification, such as viscosity modification or partial polymerization, so as to better immobilize the particles comprised therein and maintain their non-uniform concentration produced by the sound waves. It is further understood that the matrix remains combined to the particles once the three dimensional pattern is produced. Since the particles remain non linked and non-polymerized, the surrounding matrix is necessary to maintain the pattern resulting from the waves. In case the particles are living material, the surrounding matrix may in addition be used as nutritional environment. The three-dimensional patterning thus denotes the assembly comprising both the matrix and the particles.

It is also understood that the vibrational wave excludes the range of frequencies related to ultrasounds. This is particular true in case the particles refers to living material.

It thus appears clear that the process of the present disclosure differs from a traditional 3D printing, wherein some particles are cured or polymerized and wherein the remaining surrounding material is then eliminated.

It is further understood that in the three dimensional pattern according to the present disclosure, the particles and the matrix provide two distinct compositions, each having different properties at least under heat or UV irradiations. The three-dimensional structures referred to in the present disclosure may thus defined multiphasic structures.

In the present disclosure, a “sample” denotes the assembly of particles in a matrix. Preferably, the matrix has a gel-like consistency wherein the particles are embedded. The properties of the matrix may be transformed so as to prevent migration of the particles.

Above and below, the expression three-dimensional structure denotes the structure resulting from the patterns produced according to the present process or from the combination of several patterns produced according to the present process. A living three-dimensional structure denotes a structure resulting from the combination of the patterns and comprising living material such as living cells.

It is a further object to the present invention to improve the viability of the produced artificial tissue.

It is also an object of the present invention to propose an improved process for the production of three-dimensional structures of biological material.

It is also an object of the present invention to propose a process adapted for the production of three-dimensional structures having more diverse and more complex combinations of starting materials.

It is also an object of the present invention to propose a process for the production of three-dimensional structures at the point of care. The point of care mentioned here denotes any laboratory dedicated to welcome and treat patients, including hospitals, private hospitals, medical laboratories, analytical laboratories. The point of care further denotes any research institutes, pharmaceutical companies, universities, public or private training organisations.

According to the invention, these aims are achieved by means of the device and the process described in the present claims.

### BRIEF DESCRIPTION OF THE DRAWINGS

The invention will be better understood with the aid of the description of some embodiments given by way of examples and illustrated by the following figures:

FIG. 1a, 1b, 1c, 1d: General view of the device according to various embodiments;

FIG. 2a, 2b, 2c: Schematic arrangement of the orientation control device;

FIG. 3a, 3b: Examples of holders;

FIG. 4a, 4b, 4c: Example of lateral damping device according to some embodiments;

FIG. 5a, 5b, 5c, 5d: Examples of lateral damping device according to other embodiments;

FIG. 6a, 6b, 6c, 6d, 6e, 6f, 6g, 6h, 6i, 6j: Examples of light emitting systems according to the invention;

FIG. 7a, 7b, 7c, 7d, 7e, 7f, 7g, 7h: Examples of container fixation means according to the invention;

FIG. 8a, 8b, 8c, 8d: Example of containers according to some embodiments;

FIG. 9a, 9b: Examples of container according to other embodiments;

FIG. 10a, 10b: Examples of holder arrangements according to embodiments;

FIG. 11: Schematic representation of the functional elements of the printing device

FIG. 12a, 12b: Examples of processes according to the present invention;

FIG. 13: Example of a process including the 3D printing of accessories

FIG. 14: Example of a sequential process wherein the each layer is built on top of the preceding layer;

FIG. 15: Example of a parallel process wherein each layer is built independently from each other;

FIG. 16: Example of pattern obtained according to the present process

FIG. 17a, 17b, 17c: Example of a container comprising internal functional elements and resulting pattern.

### DETAILED DESCRIPTION OF POSSIBLE EMBODIMENTS OF THE INVENTION

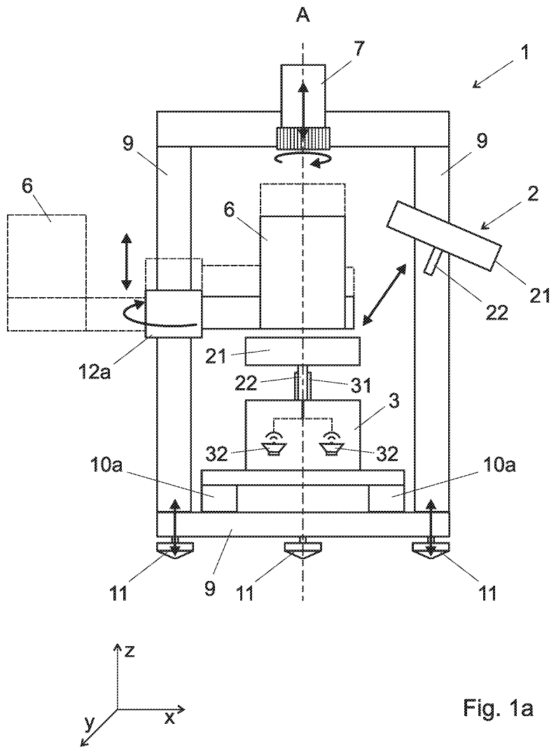

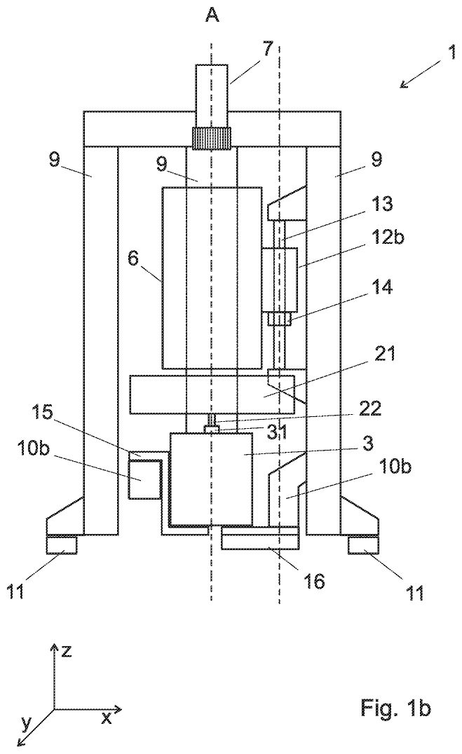

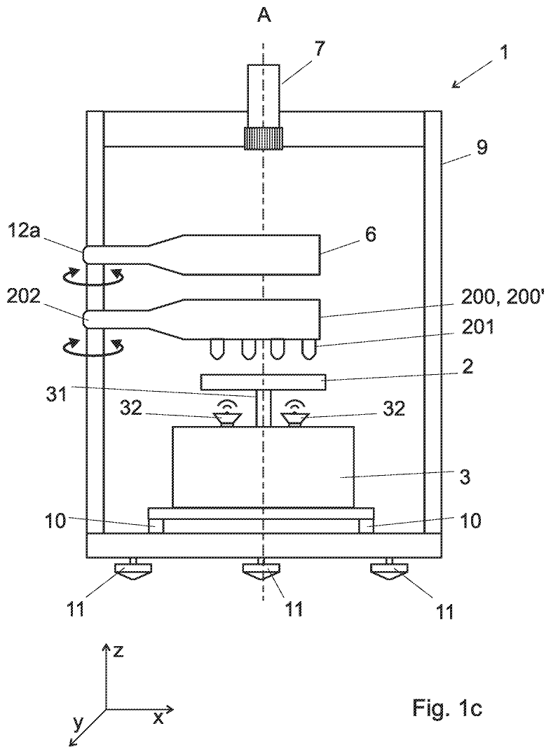

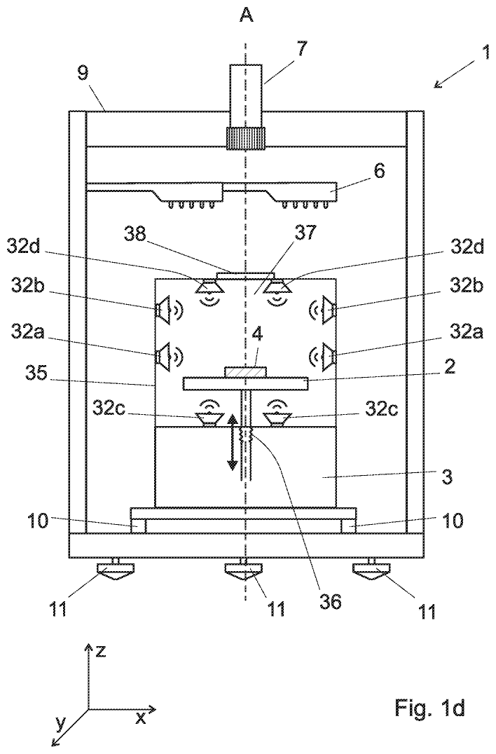

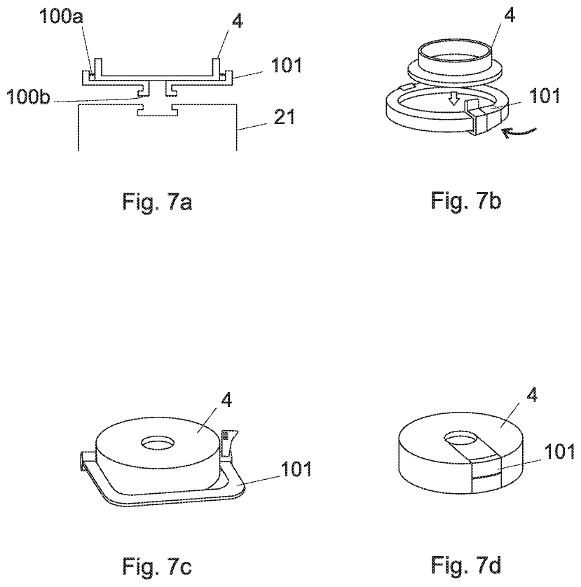

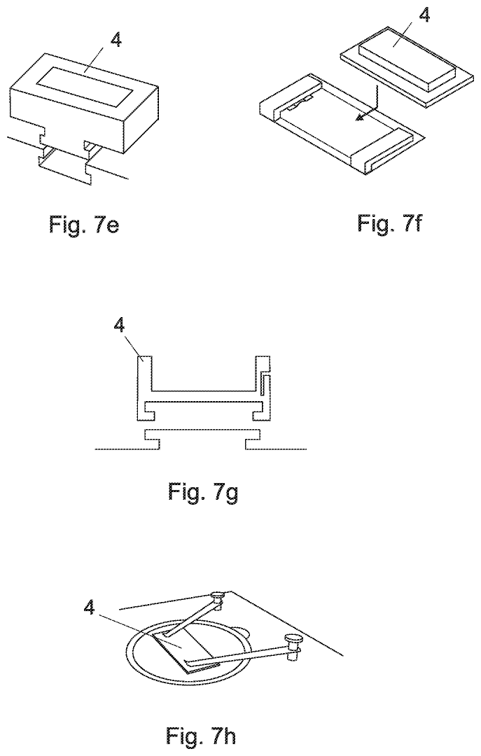

FIGS. 1a, 1b, 1c, 1d show a general arrangement of the patterning device 1 according to various embodiments of the present invention. The patterning device 1 comprises a pattern generator 3 and a holder 2 connected to the pattern generator 3. The holder 2 is adapted to hold a sample container 46 comprising the particles P to be arranged in a three-dimensional structure. The sample container 46 is placed on the holder 2 by the mean of a container fixation means 4. The mixture comprising the particles P and the matrix M is below referred to as the sample S. The holder 2 is connected to the pattern generator 3 in such a way to transmit the vibrational waves W generated by the pattern generator 3 to the container fixation means 4, comprising a sample container 46 and to the particles P it contains. To this end, the holder 2 comprises a holder plate 21 on which can be arranged the container fixation means 4, or to which are integrated the container fixation means 4, and a holder connection means 22 allowing its mechanical connection to the pattern generator 3. The pattern generator 3 has a generator connection means 31 adapted to cooperate with the holder connection means 22 and to maintain the holder 2 in position. The holder plate 21 of the holder 2 comprises a container positioning means 100 (FIGS. 7a-7h) adapted to maintain the container fixation means 4 firmly positioned on the holder plate 21.

The pattern generator 3 is here understood as equivalent to a sound wave generator in the sense that is allows to produce compression waves similar to the sound waves. It is however not limited to a mere speaker. The waves produced by the pattern generator 3 may be audible or not by a human user. The quality of the waves emitted by the pattern generator 3 should be very high to produce a clear pattern within the sample, which may be difficult or impossible with a speaker.

The container 46 may remain open or be closed with a lid.

The particles P are comprised in a matrix M, the properties of which can be modified during the process of producing the three-dimensional structures. The matrix M may contain to this end components which can react under light, and in particular under UV light, or under heat, or under other physical or chemical conditions. The patterning device 1 comprises at least one transformation device D adapted for the transformation of the matrix M. Such transformation device D includes lights such as UV, UV-visible, or infrared lights, heat plate, oven, microwave generator, and any device adapted to induce a transformation in the matrix M. In particular, the patterning device 1 comprises a light emission system 6 adapted to initiate the transformation of the matrix M under light irradiation. Alternatively or in addition, the matrix M may comprise chemical components which can react under heat. Such reactions include chemical or temperature-induced polymerisation or crosslinking. The patterning device 1 may comprise to this end a heat source such as infrared lights. The infrared lights may be included in the light emission system 6 or be part of a distinct device.

The patterning device 1 comprises a picture recorder 7 focused on the sample S. The picture recorder 7 is adapted to monitor the pattern of particles P in the sample container 46 when it is under sound wave exposure, or before, or after. It thus allows a real time monitoring of the patterning process. Alternatively or in addition, the picture recorder 7 can record the shape of the pattern, including resulting from the wave exposure of the sample S. The picture recorder 7 may be a video system, such as a camera, an infrared camera, an ultrafast camera, or any related device, which is focused on the sample 5 under production. The picture recorder 7 may be coupled to a picture analyser 8, adapted to recognize patterns, including predetermined patterns, of the particles P in the sample container 46.

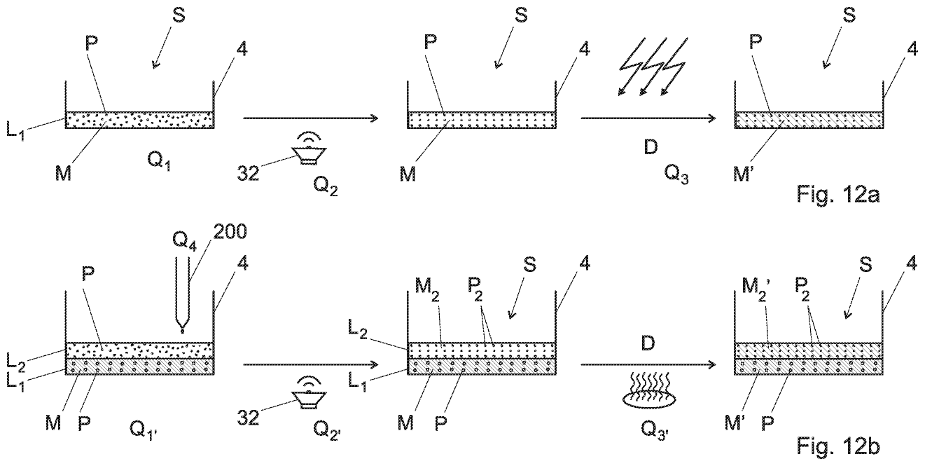

The patterning device 1 preferably comprises a frame 9, wherein the light emission system 6 and the picture recorder 7 are arranged. In particular, at least one of the light emission system 6 and the picture recorder 7, preferably both of them, are adjustable on the frame 9. The light emission system 6 is advantageously connected to the frame 9 in a way to take at least two positions, one first position being above the holder 2 and the sample container 46, the second position being remote from this first position. To this end, the light emitting system 6 is orientable on the xy plane. It is for example connected to the frame 9 by means of a rotatable connector 12a (FIG. 1a) or 12b (FIG. 1b). The rotatable connector 12a, 12b may be connected directly to the frame 9 or to a guide 13 (FIG. 1b). Alternatively or in addition, the light emitting system 6 is adjustable along the vertical axis z in a way to adjust the distance between the container fixation means 4, including the sample container 46, and the emitting lights 61 of the light emitting system 6. To this end, the rotatable connector 12a, 12b is allowed to slide either along a vertical beam of the frame 9, or along the guide 13. The position of the light emitting system 6 may be adjusted either manually or by means of a motor (not represented). A locker 14 may be used to lock the light emitting system 6 at a given position, including either a given height above the holder 2, or an angular position, or both height and angular position.

The pattern generator 3 may also be arranged on the frame 9, by means of one or more damping devices 10, which reduces the noise and the vibration of the patterning device 1. Alternatively, the pattern generator 3 is independent of the frame 9. According to an embodiment, the pattern generator 3 is placed on a set of silent blocks 10a on a transversal beam of the frame 9 (FIG. 1a). According to another possible embodiment, the pattern generator 3 is placed on a support 15 comprising a counterweight 16 allowing to reduce the effect of the vibrations produced by the pattern generator 3. The support 15 may be connected to the frame 9 by means of a set of silent blocks 10b (FIG. 1b).

The frame 9 may comprise 1, 2, 3 or more vertical pillars. It may in addition comprise at least one top horizontal beam to which is placed the picture recorder 7. Other arrangements of the frame 9 are possible.

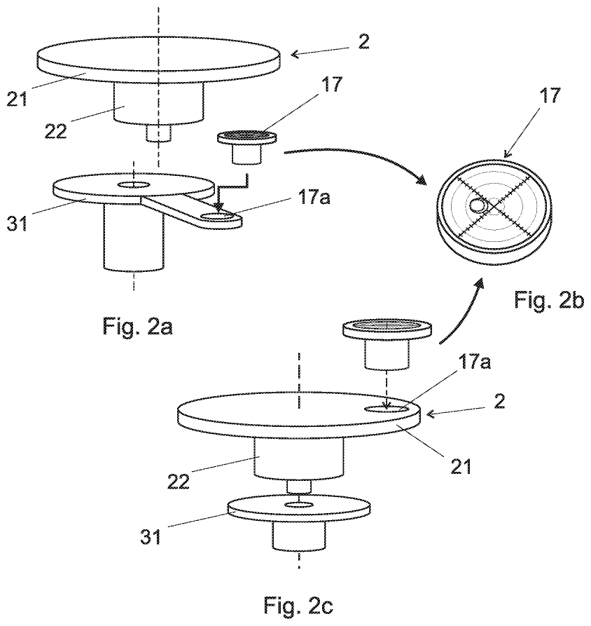

The frame 9 is placed on several feet 11. At least one of the feet 11 is adjustable, preferably two feet 11 or more can be adjusted. The frame of the patterning device 1 advantageously comprises three feet 11, two of which are adjustable in order to adjust the level of the patterning device 1, and in particular the level of the holder 2 at a horizontal orientation. To this end, the patterning device 1 comprises a levelling control means 17 adapted to control the orientation of the plate 21 of the holder 2 with regard to the horizontal plane xy. Such orientation may in certain cases preferably be precisely adjustable to avoid any defect in the pattern produced by the pattern generator 3 in the sample S. The orientation of the holder 2 is preferably essentially horizontal, meaning that the top surface of the plate 21 of the holder 2, on which is placed the container fixation means 4, is in the xy plane. The deviation of the orientation of the holder 2 with regard to the xy plane should preferably be lower than around 0.5° or less, 0.3° or less, 0.1° or less, even more preferably equal to, or lower than around 0.05°. The levelling control means 17 may be a visual orientation control means such as a spirit level (FIGS. 2a, 2b, 2c). The spirit level can be removably placed on the holder 2, or on the pattern generator 3 to which is connected the holder 2, or at another place on the patterning device 1, which allows the precise determination of the orientation of the top surface of the plate 21 of the holder 2. It can be for example placed in a hole 17a adapted to receive it without deviation. To this end, the edge of the hole 17a and the edge of the levelling control means 17 may have a complementary conical shape in such a way that the respective position of the patterning device 1 and the levelling control means 17 is always the same. According to such an arrangement the levelling control means 17 can be removed and preserved when the wave generator 3 is activated. Other devices such as an accelerometer or laser detection device may be used alternatively. Alternatively, the levelling control means 17 or the other devices used to determine the orientation of the plate 21, can be firmly included or incorporated in a part of the patterning device 1 such as the holder 2. This arrangement avoids the imprecisions which may occur with a removable device, mainly across the time, after several placement and displacement of the levelling control means 17. The levelling control means 17 can be read directly by the user. Alternatively or in addition, the levelling control means 17 can be recorded and analysed by the picture recorder 7 and the analyser 8 or another suitable device. Alternatively or in addition, the levelling control means 17 may be object of an image projected on a screen or a display visible by the user. Alternatively or in addition, the levelling control means 17 may generate an electronic signal such as an alert or an error signal and/or a signal indicating that the level complies, or does not comply, with the requirements.

According to an embodiment, the patterning device 1 is arranged according to a vertical axis A, wherein the pattern generator 3 is at the bottom, wherein the holder 2 is above the pattern generator 3 and wherein the light emitting system 6 is above the holder 2, or surrounding the holder 2, and wherein the picture recorder 7 is at a top position, and can be focused on the sample S under preparation.

The patterning device 1 is conveniently arranged in a way that the light emitting system 6 can be activated above the sample S under preparation, in the sample container 46, concomitantly to the pattern generator 3 activation. In addition, the picture recorder 7 may be activated concomitantly to the light emitting system 6 and the pattern generator 3. The light emitting system 6 may remain above the sample S under preparation, in the sample container 46, whether it is activated or inactivated. By this way, the light irradiation of the sample S can be switched on and off without removing or replacing the light emitting system 6 above the sample S.

The patterning device 1 is easily adaptable to various applications. In particular, the light emitting device 6 may be removed from the patterning device 1 and replaced by a different light emitting system 6. Alternatively, the light emitting system 6 comprises several different emitting lights or emitting group of lights 61, which can be independently activated according to the needs. In particular, light or group of lights 61 having different wavelength or different power can be used. The light emitting system 6 may be provided with a light protection screen (not represented), preventing the emitted light from dispersing around the printing device 1. Alternatively or in addition, safety glasses or face shields are separately provided for the user.

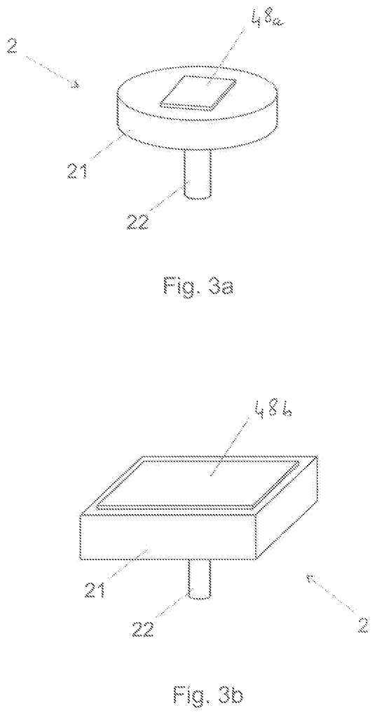

The holder 2 can preferably easily be removed from the pattern generator 3 and replaced by a different holder 2 according to the specific needs. As an example, the holder 2 may be adapted to an individual dish 48a (FIG. 3a) or to a wellplate 48b (e.g. plates with single, 6-well, 12-, 24-, 48-, 96-wells or any other number of wells) (FIG. 3b) or to both of them. The holder connection means 22 may be in particular manually connected to, and disconnected from, the generator connector 31, without any tool. A clamping mechanism, comprising a spring can for example be used to maintain the holder 2 in good position. Alternatively, the holder 2 may be placed on a carousel comprising several holders 2 of different types. Such a carousel can be coupled to, and uncoupled from the pattern generator 3 by means of a removable connection means.

In another embodiment, the picture recorder 7 may also be easily removed from the frame 9 and replaced by a different picture recorder 7. For example, a camera active in the visible field may be replaced by an infrared camera, or by a high speed camera, or by another type of picture recorder 7. The replacement of the picture recorder 7 is preferably possible without any tool. Manual clamping or locking systems are advantageously used.

Advantageously, the patterning device 1 is provided with a set of various accessories including two or more different emitting lights or groups of lights 61, two or more different picture recorders 7, two or more different holders 2. The patterning device 1 can thus be tuned on demand according to the desired experiment or production needs. In a convenient arrangement, each of the elements such as light emitting system 6, picture recorder 7 or holder 2, placed on the patterning device 1 is automatically recognized by a control unit 81. The corresponding set up can be automatically uploaded to the control unit 81 to properly pilot the corresponding device. Alternatively, the characteristics of the elements may be manually loaded to the control unit 81 by a human-machine-interface (HMI) device 82.

As a preferred arrangement, the positions of the holder 2 along the horizontal directions x and y, respectively, are not adjustable. In other words, the position of the holder 2 within the xy plane is predetermined. This prevents any lateral movement of the holder 2, in particular when the pattern generator 3 is activated. Thus, the position of the container fixation means 4 on the top surface of the plate 21 is predetermined, and the lateral position of the holder 2 is also predetermined. The term “predetermined” should be here understood as being not tuneable or adjustable by the user. In case the holder 2 is part of a carousel, the position of the corresponding carousel is predetermined.

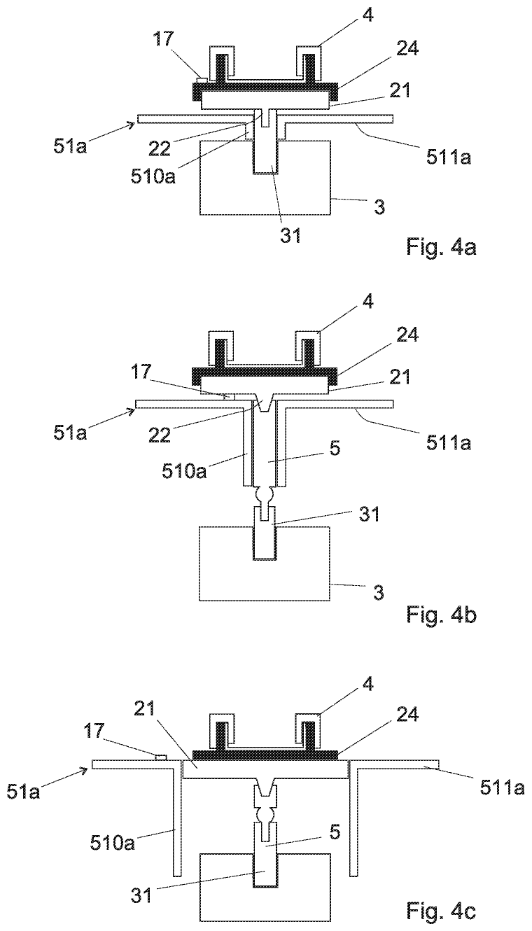

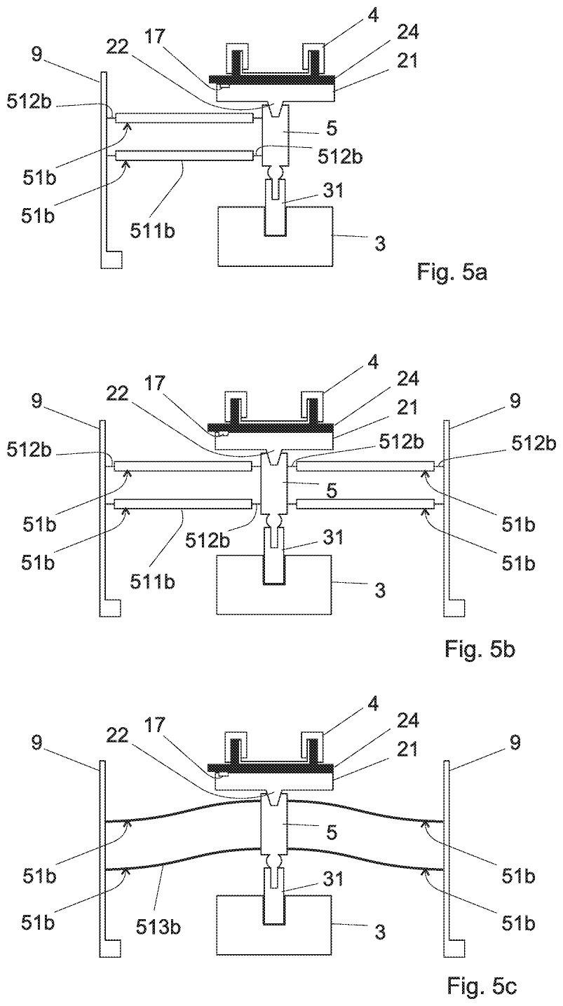

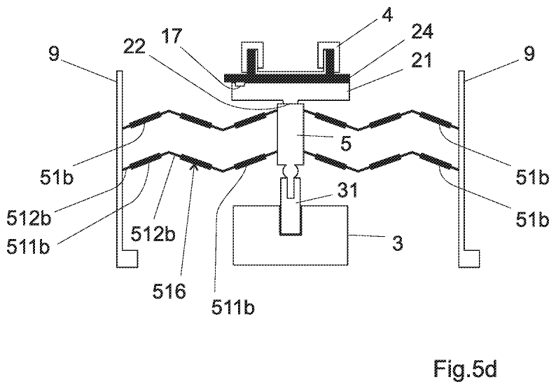

In addition, deviations in the xy plane resulting from vibrations are also prevented or at least minimized. To this end, one or more lateral damping devices 51 (FIGS. 4a, 4b, 4c, 5a, 5b, 5c, 5d) are arranged to prevent the lateral vibrations of the holder 2 and the sample S under preparation. Such an arrangement further increases the quality of the pattern and in consequence the resolution and the viability of the three-dimensional structure in the sample container 46. In particular, the holder connection means 22 or the generator connection means 31 may be directly surrounded, or essentially directly surrounded, by a lateral damping device 51a (FIG. 4a). Alternatively, the holder connection means 22 and the generator connection means 31 are not directly connected to each other, but through an intermediate connector 5, which is itself surrounded by a lateral damping device 51a (FIG. 4b). Alternatively, the holder 2 is itself surrounded by a lateral damping device 51a (FIG. 4c). To this end, the edge of the holder 2 can for example be prolonged downward to form a skirt fitting with the lateral damping device 51a. Such a lateral damping device 51a may comprise a tube 510a, surrounding either the holder connection means 22, or the generator connection means 31, or an intermediate connector, or the edge of the holder 2. The lateral damping device 51a further comprises a support 511a which is independent from the pattern generator 3, and which allows to maintain the tube 510a in position.

The damping device mentioned herein may be important to provide a good quality of patterns. In particular, the damping elements may be arranged and designed to absorb at least a part of reflected waves and resonance frequencies interfering with pattern generation. Preferably, the damping elements are adapted to absorb all the frequencies not directly emanating from the pattern generator 3 so that the sample receives exclusively or substantially exclusively the waves produced by the pattern generator 3 without distortion.

The patterning device 1 may in addition comprise an illumination system allowing to visualize the sample during the process and after the process. In particular, pictures of the pattern may be easily taken by the picture recorder either in a continuous manner or at regular time intervals or after each step of a process. Such an illuminating system is thus independent from the transformation device D and any light system described therein for the transformation of the sample. The illumination system has no impact on the sample itself but merely allows to visualise it. The illumination system may thus provide the necessary light directly on the surface of the sample. The angle of illumination of the sample can be varied, providing illumination from the side, thereby allowing to improve visualization of the sample by exploiting the reflection of light from the sample surface at different angles, providing better contrast. Alternatively or in addition, the illumination system is configured to provide light from below the sample, so that the light crosses the sample and allows the picture recorder to image it. In other words, the illumination system is configured to allow backlighting the sample. Light used for illumination of the sample can be either non-polarized or polarized in order better visualize patterns forming under the surface of the sample. Different wavelengths of illumination can also be used in order to exploit fluorescent moieties potentially included in the sample for improved visualization or to improve visualization in other ways related to illumination by and absorption of specific wavelengths. Other combinations of polarizing and/or colour filters can be envisioned to be placed between the illumination system and the picture recorder 7 with the objective of improving visualization of the sample before, during and/or after patterning.

According to one embodiment, the illumination system is an external module being adapted or adaptable to the present patterning device so as to illuminate the sample. Such illumination system may thus be easily removed or exchanged, depending on the needs. Such a removable arrangement allows for example to adapt either the wavelength or the angle of illumination or to include or remove a backlight function.

According to another embodiment, the illumination system is integrated to the patterning device. For example it can be coupled or combined or integrated with the transformation device D or with another feature of the patterning device.

FIGS. 5a, 5b, 5c and 5d show alternative arrangements wherein the holder connection means 22 and the generator connection means 31 are connected by means of an intermediate connector 5 and wherein this intermediate connector 5 is connected to the frame 9 of the patterning device 1 by means of one or more flexible arms 51b. Such flexible arms 51b may comprise a rigid portion 511b which prevents the lateral movement of the holder 2 and a flexible attachment 512b at its extremities, allowing a vertical deviation of the holder 2 (FIG. 5a, 5b). Alternatively, the flexible arm 51b may take the form of a leaf spring 513b (FIG. 5c). One of the extremities of each leaf spring is linked to the frame 9 of the patterning device 1 and the other one is connected to the intermediate connector 5. Alternatively, the flexible arms 51b may comprise several rigid portions 511b and several flexible parts 512b to form a leaf spring specifically adapted to the holder 2. Other arrangements or combination of these arrangements can be used. The flexible arms 51b can be organized at one side of the intermediate connector 5 or at two opposite sides or, in case the patterning device 1 comprises 3 or more vertical pillars 9, one or several flexible arms 51b can be connected to each of these pillars 9.

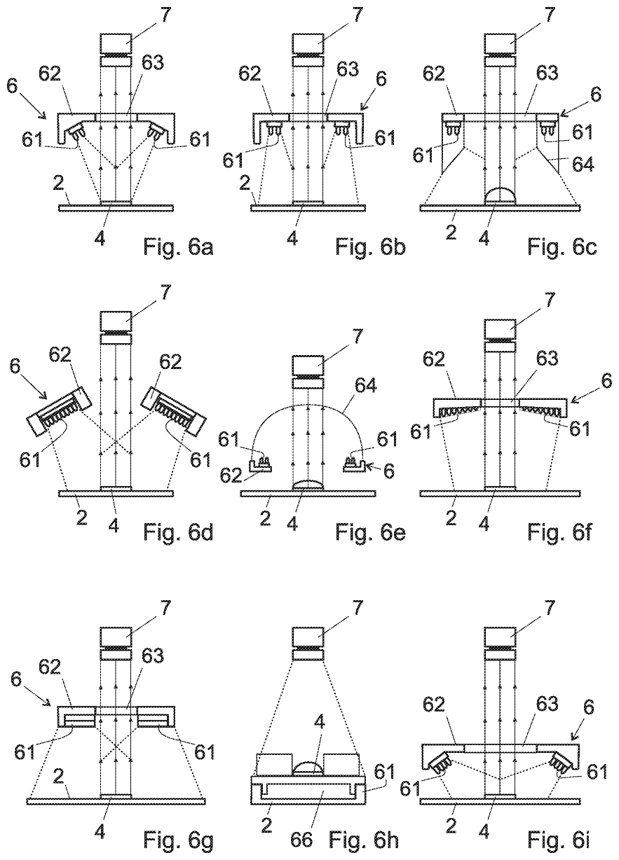

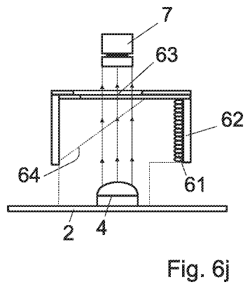

FIGS. 6a to 6i show various alternatives related to the light emitting system 6. The light emitting system 6 comprises one or more emitting lights 61, positioned on one or several light frame 62 in a way to irradiate the sample 5 in the sample container 46, when it is positioned on the holder 2. The emitting lights 61 are for example UV or UV-visible emitting lights usually applied for the polymerisation of chemical components reactive under these wavelengths, and present in the sample S. The emitting lights 61 may be traditional UV or UV-visible or specific LED or any suitable emitting device. Depending on the arrangement of the emitting lights 61, the light emitting system 6 may comprise one or more reflecting surfaces 64 to focus the emitted light toward the sample S positioned on the holder 2. The light frame 62 may be included to the holder 2 (FIG. 6h) and irradiate the sample S from the bottom. In such a configuration, the plate 21 of the holder 2 comprises a recess 66 closed by a transparent sheet on which is placed the container fixation means 4. A combination of one or more arrangements described herein is possible. For example, a light irradiation of the sample S may occur either from the bottom, either from the top, or from the edge, or from several of these directions. The light frame 62 or the group of light frames 62 are arranged in a way to maintain the sample S visible from the picture recorder 7. For example, the light frame 62 can be circular with a central hole 63 corresponding to the optical pathway of the picture recorder 7. The orientation of the emitting lights 61 or their distance with the sample S, or both the orientation and the distance may be manually or automatically adjustable.

The light frame 62 may be adapted to receive several types of different emitting lights 61, irradiating for example in different optical spectral domains or at different wavelengths. In addition, the light frame 62 may be provided with infrared lights adapted for warming the sample S. This is particularly convenient when a temperature-induced polymerisation of the matrix M is necessary instead of a polymerisation triggered by UV irradiation. Different chemical components can even be included in the matrix M of the sample S, which may react under different conditions. The light emitting system 6 advantageously allows to activate alternatively several lights 61 or group of lights 61.

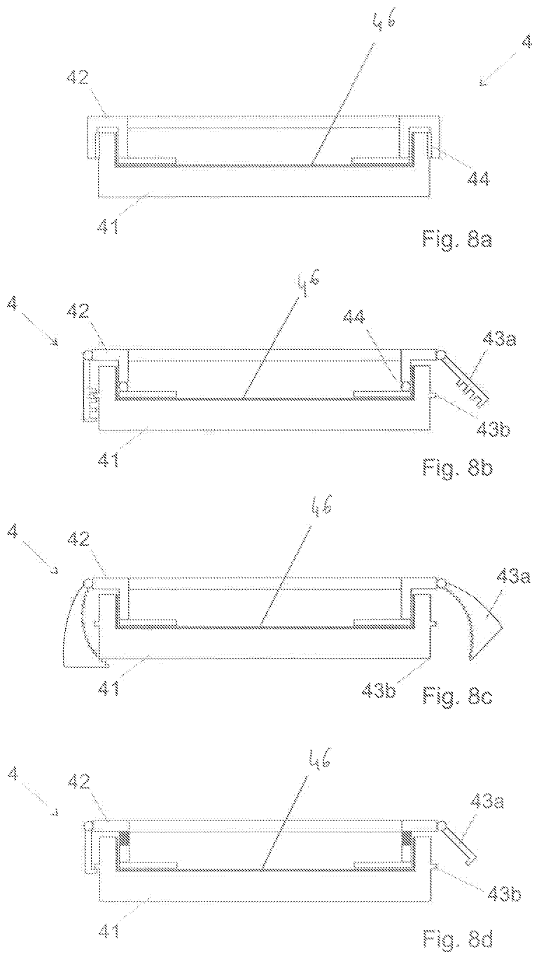

The container fixation means 4 may have any geometry. It can have for example a square, rectangular, circular, elliptical enclosure. FIGS. 8a, 8b, 8c, 8d show examples of containers fixation means 4. The container fixation means 4 comprises a base 41 holding a sample container 46 in which are placed the matrix M and the particles P. The container fixation means 4 further comprises a removable cap 42 placed above the base 41 and adapted to fit, preferably hermetically fit, with the base 41. The removable cap 42 can be adjusted on the edge of the base 41 and maintained merely by friction force (FIG. 8a). A sealing 44 may be placed between the base 41 and the removable cap 42 to increase the friction force while maintaining the container fixation means 4 closed, preferably hermetically closed. Alternatively, the removable cap 42 may be adapted to the base 41 by means of a cap clamping arrangement 43. Such cap clamping arrangement 43 comprises for example a first member 43a linked to the cap 42 and a second member 43b linked to the base, the first 43a and the second 43b members being adapted to cooperate. The cap clamping arrangement 43 can be adjustable in such a way to be adapted for several closing positions (FIGS. 8b, 8c). Several closing positions include either a progressive closing force (FIG. 7c) or several predetermined closing positions (FIG. 8b). Alternatively, only one closing position is allowed (FIG. 8d).

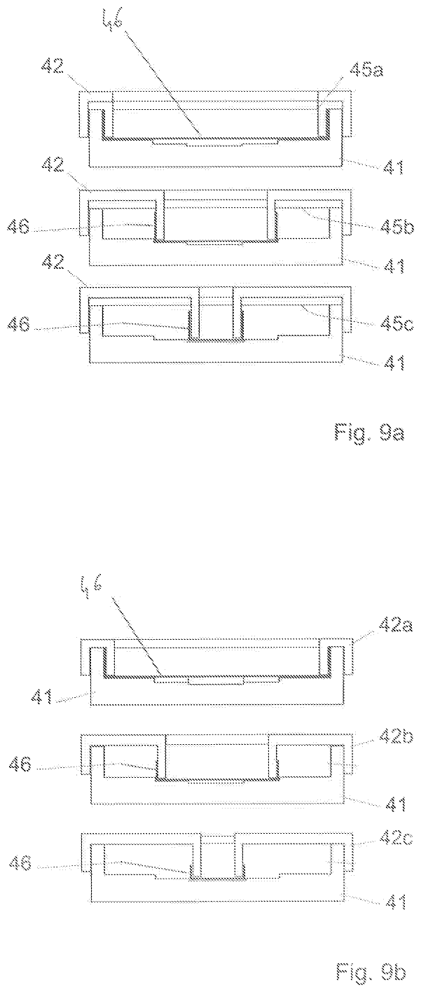

The container fixation means 4 may be itself modular. A given base 41 can be adapted to receive various types of caps 42. FIG. 9b shows various configurations wherein a given base 41 is combined with different caps 42a, 42b, 42c. Such caps 42a, 42b, 42c may be used to facilitate the fixation of sample containers 46 of different shape and dimensions on a given base 41. Alternatively, a cap adaptor 45 can be used to facilitate the fixation of sample containers 46 of different shape and dimensions on a given base 41. FIG. 9a shows examples wherein a given base 41 is combined with different cap adaptors 45a, 45b, 45c. A single removable cap 42 can thus be used with the base 41.

The container fixation means 4 may be partly or fully transparent to light, and in particular to UV-visible light. Either the base 41 or the cap 42 of the container fixation means 4, or both the base 41 and the cap 42, can be transparent to such light. The cap 42 may also be fully transparent to such light or partially transparent to such light. The cap 42 and the base 41 may be independently made of glass, quartz, hard or soft polymer, or of a combination of these material.

The container fixation means 4 is preferably fixed on the surface of the plate 21 of the holder 2 by a positioning means 100 allowing to removably position the container fixation means 4 on the holder 2 at a predetermined position. The positioning means 100 may be an intermediate element 101 having a first positioning element 100a and a second positioning element 100b, as shown in FIG. 7a. The first positioning element may be a spring adapted to maintain the container fixation means 4, and the second positioning element may be a geometrical shape complementary to the geometrical shape of the holder 2 in such a way to secure the intermediate element 101 on the holder 2. Such intermediate element 101 may comprise a spring combined to a clip (FIG. 7a), a rotative clip (FIG. 7b), a clamping holder (FIG. 7c, 7d), pressing arms (FIG. 7h). Alternatively, the container fixation means 4 may comprise itself the necessary positioning means, such as rails (FIG. 7e, 7f) or flexible clips (FIG. 7g).

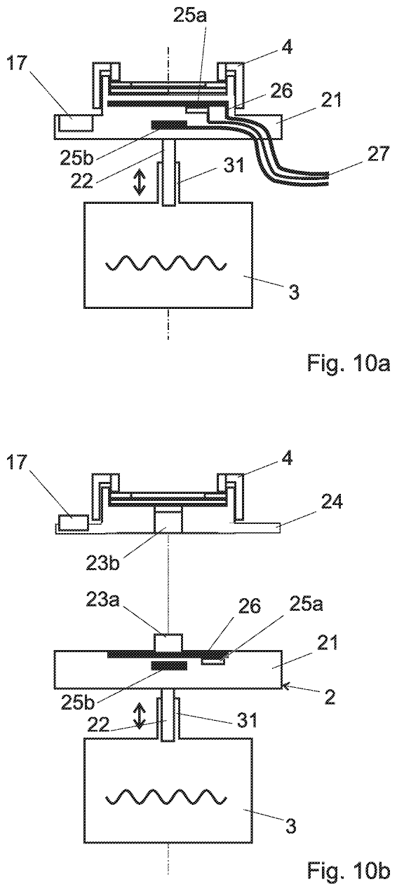

The plate 21 of the holder 2 may be arranged to directly receive a container fixation means 4. To this end, it bears all the necessary container positioning means 100 to maintain the container fixation means 4 at the proper position (FIG. 10a). The plate 21 of the holder 2 is alternatively arranged to receive a container adaptor 24 (FIG. 10b). The container adaptor 24 allows to easily replace the container fixation means 4 on the holder 2, including exchanging containers fixation means 4 adapted for sample containers 46 of different sizes or different shapes. The container adaptor 24 is maintained on the plate 21 of the holder 2 by means of an adaptor connexion means 23a, 23b. The adaptor connexion means 23a, 23b preferably allows to manually assembly or disassembly the container adaptor 24 from the plate 21. The container adaptor 24 preferably comprises all the necessary container positioning means 100 to maintain the container fixation means 4 at the proper position once the container adaptor 24 is placed on the plate 21.

In a preferred embodiment, the holder 2 may be provided with one or several sensors 25a, 25b. One of a temperature sensor 25a and a vibration sensor 25b is at least included in the plate 21 of the holder 2, preferably both temperature sensor and vibration sensor are integrated in, or combined to, the holder 2. The plate 21 advantageously comprises in addition a thermal management device 26, allowing to warm the container 46 including the particles P and the matrix M at a desired temperature higher than the ambient temperature. The temperature sensor 25a together with the thermal management device 26 allow to regulate the temperature of the sample S under preparation. The temperature may be defined according to predetermined values or sequences of values adapted for the preparation of the samples S and in particular for the polymerisation of the chemical components present in the matrix M. The heat duration, the temperature ranges and the rates of temperature variation may be object of several programs. The temperature can thus be modulated between 20° C. and 200° C., preferably, between 20° C. and 100° C., most preferably between 20° C. and 50° C. The thermal management device 26 may in addition be adapted to cool the sample S at a temperature below the ambient temperature, such as below 15°, or 10° C. or 5° C. In a very most preferred arrangement, the thermal management device 26 is a temperature regulation device adapted to regulate or modulate the temperature of the sample S under preparation at a temperature comprised between around 4° C. to around 40° C.

The thermal management device 26 may denote a distinct transformation device D allowing to transform the matrix M of the sample S. Alternatively, the thermal management device 26 is a part of a transformation device D comprising several heating devices such as a heating plate, a set of infrared lights, a microwave generator and any other devices usable to heat the sample S and transform the matrix M.

The plate 21 or the container adapter 24 may be provided with one or several levelling control means 17.

The sensors 25a, 25b included in the holder 2, as well as the thermal management device 26 and any other electrical elements, may preferably be connected to a control unit 81 by means of electrical connectors 27 arranged on the holder 2. Such electrical connectors 27 may be independently plugged to, or unplugged from the control unit 81. Alternatively, the sensors 25a, 25b, the thermal management device 26 and other potential electrical elements present in the holder 2 are automatically plugged when the holder 2 is placed on the pattern generator 3.

The holder 2 may in addition be connected to, or equipped with a cooling device (not represented) adapted to cool or freeze the sample S. The cooling device can be integrated to the patterning device 1. Any known cooling device may be used and adapted for this purpose.

Although the user can manually add or inject material to the sample S, for example before, during or after the patterning process under sound waves, the device 1 may advantageously be provided with an injection device 200 comprising one or more injectors 201 adapted to inject material into the sample container 46, either to inject the matrix and particles into the sample container 46, on top of the particles P and the matrix M already present in the sample container 46, or in the bulk of the matrix M already present in the sample container 46 (FIG. 1c). The injection device 200 may be linked to the frame 9 of the device 1 in a way to be placed either above the sample S or remote from the sample S. A rotating connection means 202 can be used to this end. The injection device 200 can be used to add particles P, matrix M or matrix elements or any other material to the sample S under preparation, as well as a combination of several different elements. The chemical components, as well the biological components, present in the added material may be different from the chemical and/or biological components already present in the sample container 46.

Using such an injection device 200 integrated to the patterning device 1 facilitates the production of the three-dimensional structures. In particular, layers L having different matrices M may be arranged one on top of the other. Such injection device 200 is preferably adapted for injecting biomaterials which participate to the production of the three-dimensional structures. The injection device 200 is adapted for any kind of injection activities and not limited to the 3D bio-printing activities. In one embodiment, such injection device 200 preferably denotes a 3D bio-printing device, adapted for the 3D printing of biomaterial.

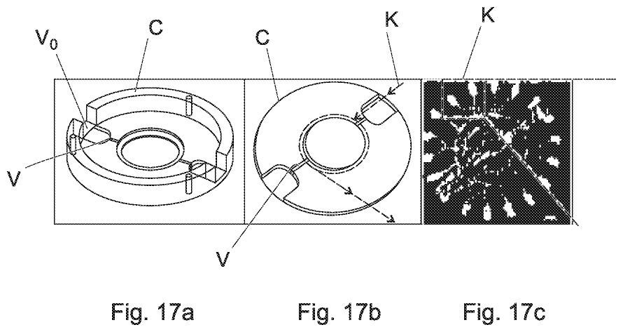

Alternatively or in addition an injection device 200′ can be used for the 3D printing of material not directly included in the three-dimensional structures. For example, accessories may be printed on demand using a non-biological material. The term accessories denotes any device or feature used in the preparation of the three-dimensional structures, including the sample containers 46 and any functional element which can be integrated or combined with the sample containers 46. In particular, the sample container 46 can be produced on demand with a predetermined geometry. Examples of sample containers 46, and the resulting patterns are shown on FIGS. 17a, 17b and 17c. In this example, circular sample container 46 is provided with a channel V crossing the internal space of the sample container 46. The channel V may have itself any geometry and participates to the geometry of a given sample container 46. Such a channel V provides at least one opening Vo at the periphery of the sample container 46 allowing to include additional material to the biomaterial filled in the sample container 46. As shown in FIG. 17b, the channel V may have a circular shape in the internal space of the sample container 46. The geometry of such a channel V is of course not limited to this specific geometry. Other shapes comprising several openings may be provided, or a web of channels may alternatively be built in the sample container 46. The channel V may be used to circulate a nutritive fluid K such as artificial or non-artificial blood, physiological fluid or any other relevant material needed for the growing and the viability of the three-dimensional structure. FIG. 17C shows a resulting three-dimensional structure wherein the cells are organized according to a specific pattern and irrigated by the circulating fluid K. Thus, the geometry of a sample container 46 should be understood as including its peripheral shape as well as any other internal shape or combination of shapes. It should also be understood that although the sound wave pattern is also determined by the peripheral geometry of a given sample container 46, this does not exclude to incorporate additional three-dimensional shapes internal to the sample container 46.

The geometry of the sample containers 46 can be determined based on the expected pattern of the particles P resulting from the sound wave exposure. For example, a library B comprising sets of parameters (B1 . . . Bm). Each set of parameters corresponding to a given experiment, can be used to determine the most adequate geometry of the sample container 46 according to a known pattern recorded in the library B. The patterns may be recorded to the library B by means of the picture recorder 7 or by any other suitable recording device. In such a set of parameters, the term “m” denotes an integer comprised between 1 and around 100, preferably between 1 and around 50. Such parameters include one or more of the sound wave characteristics such as its amplitude A and its frequency F, the geometry of the sample container 46, the rheological characteristics of the matrix M and any other relevant parameters such as the nature of the particles P, the environmental conditions such as the temperature, the atmosphere conditions, the pressure conditions, the gravity conditions and any other monitored parameters of the experiment.

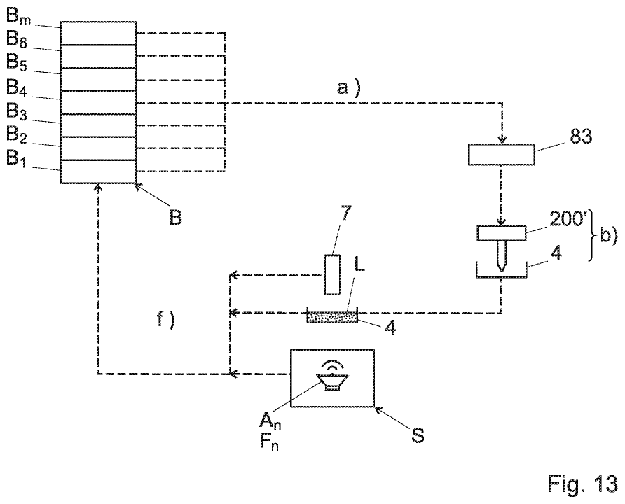

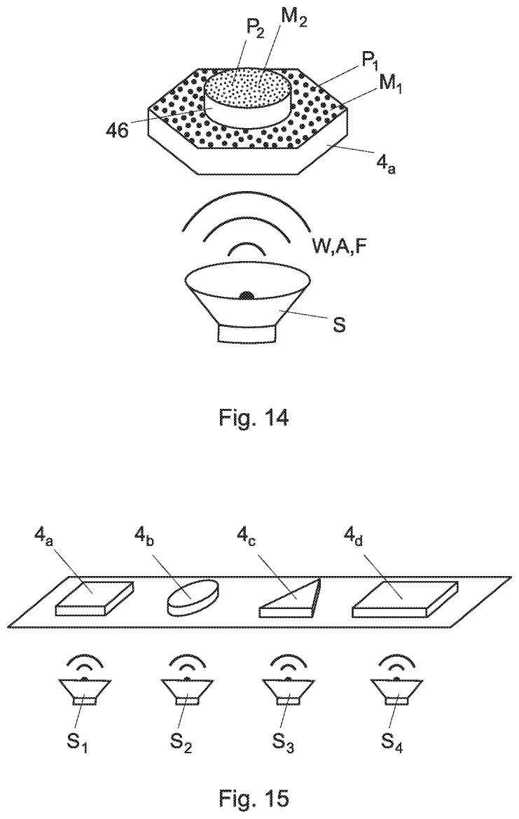

According to an optional embodiment, the geometry of the sample containers 46 may be created based on a library B comprising several sets of parameters (B1 . . . Bm) using a computing program or an artificial intelligence module such as the artificial intelligence 83 of the patterning device 1 (FIG. 13). Such an artificial module 83 may be integrated or combined to the command unit 81. Such artificial module 83 can be integrated to the patterning device 1 or remote to the patterning device 1 and connected to it by means of usual communication means such as internet or private protocols. A secure connection protocol may be envisaged for allowing access to authorized users. A library B may also be integrated to the patterning device 1, or remote to the patterning device 1. Access to the library B may be done through secure protocols.

The patterning device 1 may comprise one or two different injection devices 200, a first injection device 200 being dedicated to the injection of biomaterial to the sample S, including the 3D-bio-printing, and a second injection device 200′ being dedicated to the 3D printing of the accessories. Alternatively, a single injection device can be used, wherein the elements of the injection device 200 such as the cartridges and the nozzle and any other features adapted for the 3D-printing of material, can be exchanged or replaced according to the need.

According to an important aspect, the injection devices 200 integrated to, or combined with, the patterning device 1 is adapted to inject material at predetermined positions on the surface or in the bulk of the sample S. To this end, it is movable at least in two planar directions X, Y. It may in addition be able to move in a vertical position along the Z axis. In addition, the injection device 200 may be oriented in a position different than the vertical position. It may be provided with usual articulation means, in a way to allow its displacement, or the displacement of a part of the injection device 200, over six degrees of freedom. The positioning of the injection device 200 can be precisely piloted by a control unit 81. The additional material injected to the sample S includes the particles P, as above defined, one or more matrix components or a mixture thereof. The injected particles P may be the same of the particles P already present in the sample S or different.

In case an injection device 200′ for injecting non biomaterial is integrated to or combined with the patterning device 1, it is movable at least in two planar directions X, Y. It may in addition be able to move in a vertical position along the Z axis. In addition, the injection device 200′ may be oriented in a position different than the vertical position. It may be provided with usual articulation means, in a way to allow its displacement, or the displacement of a part of the injection device 200′, over six degrees of freedom. The positioning of the injection device 200′ can be precisely piloted by the control unit 81.

In addition, the injection devices 200, 200′ are adapted to inject predetermined volumes. The activation of the injection devices and the injected volumes can be precisely piloted by the control unit 81.

The polymerisation process of the matrix, in each layer may be identical or different from one another. A matrix M1 of a first layer L1 may for example be polymerised under light irradiation and the matrix M2 of a second layer L2 may be polymerised under heat, depending on the properties of the chemical components in each of the matrices M1, M2. The heat may be provided either by the light emitting system 6, in case infrared lights are present, or by the heating thermal management 26 or by both emitting system 6 and the thermal management device 26.

The pattern generator 3 comprises one or several vibration generators 32 or set of vibration generators 32 either all identical or different. Each vibration generator 32 or set of vibration generators 32 of the pattern generator 3 is adapted to provide a wave vibration which is transmitted to the sample S through the holder 2. The vibration generators 32 can be for example mechanically connected to the generator connection means 31 to transmit the vibration to the sample S through mechanical vibration (FIG. 1a). The vibration generators 32 can also be speakers generating sound waves and transmitted to the sample S through air or another appropriate medium. Alternatively or in addition, the pattern generator 3 comprises one or more vibration generators 32 arranged near the holder 2, and not being mechanically connected to the generator connection means 31 (FIG. 1c). The the vibration generated by such vibration generators 32 is directed to the holder 2 and allows the sample S to vibrate in a predetermined way.

According to an embodiment, the pattern generator 3 comprises or is connected to several vibration generators 32 arranged in a three-dimensional space (FIG. 1d). In particular, vibration generators 32c may be arranged under the holder 2, vibration generators 32d may be arranged above the holder 2, vibration generators 32a, 32b may be arranged beside the holder 2, in such a way to provide multiple sources of vibrational waves. The vibration generators 32c and 32d provide vibration sources on different planes. It should be understood that the vibration generators 32d may be under the holder 2 on a different plane than the vibration generators 32c. Superimposed layers L of the sample S may thus be exposed to specific vibration sources. The vibrations may in addition be combined to provide in a given layer L a specific pattern. Layers L having an increased thickness compared to the known processes can then be used to build a pattern under exposure to vibration. Alternatively or in addition, lateral vibration generators 32a, 32b are provided. The waves originating from these lateral vibration generators 32a, 32b may be used sequentially with the waves originated from the planar vibration generators 32c, 32d, or concomitantly. The patterning device 1 as such arranged allows to provide a three-dimensional pattern in a given layer L, instead of a bi-dimensional pattern usually obtained under exposure to vibrational waves. Such apparatus allows to improve the speed and the diversity of the produced three-dimensional structures.

The holder 2, and consequently the container fixation means 4, including a sample container 46, may be surrounded by walls defining a closed space 35. Such closed space 35 allows to place the sample S under special conditions such as special atmosphere, or specific pressure conditions, or specific temperature conditions or special gravity conditions, or a combination of several specific conditions. Special atmosphere includes oxygen rich atmosphere and oxygen poor atmosphere or oxygen free atmosphere. Specific pressure conditions include high pressure conditions such as 2, 3, 4 or more bars pressure, as well as pressure lower than the ambient pressure, which can be reached by means of one or more vacuum pumps. Special gravity conditions mainly include 0-gravity conditions or almost 0-gravity conditions, at least reduced gravity conditions.

The holder 2 may in addition or alternatively be connected to the pattern generator 3 by an actuator 36 allowing a vertical adjustment of the position of the sample S in the closed spaced 35. When vibration generators 32a, 32b are arranged along the vertical z axis, the height of the sample S can be modulated by means of the actuator 36, in such a way to properly receive the waves originating from the vibration generators 32a, 32b. In addition, the holder 2 may be precisely placed at a convergence of various wave sources to provide a specific pattern.

The various elements of the patterning device 1, although separately described for ease of presentation may be combined without restriction. The patterning device 1 can then be conceived as a modular arrangement. The combination of the above described elements, including the pattern generator 3, the transformation devices D, the injections devices 200, 200′, allow to produce a three-dimensional structure without or substantially without displacement of the sample S. In other words, all the steps necessary to produce such three-dimensional structures can be performed by means of the patterning device 1.

According to an important aspect, the patterning device 1 comprises all the necessary functional elements such as to perform the preparation of the three-dimensional structures without or substantially without manipulating the sample S. In other words, all the necessary steps are performed with an optimised time and reproducibility. In addition, all the steps or substantially all the steps of the process can be performed at a point of care.

The closed space 35 may be provided by a closable opening comprising a cap 38, preferably placed on the top. Such closable opening 37 allows the injection of additional material by means of an injection device 200. Alternatively, such an injection device 200, 200′ is included to, or integral with the closed space 35. The top wall of the closed space 35 comprises also a transparent area allowing the light irradiation of the sample S and image recordation. The transparent area may be provided on the cap 38 of the closable opening 37.

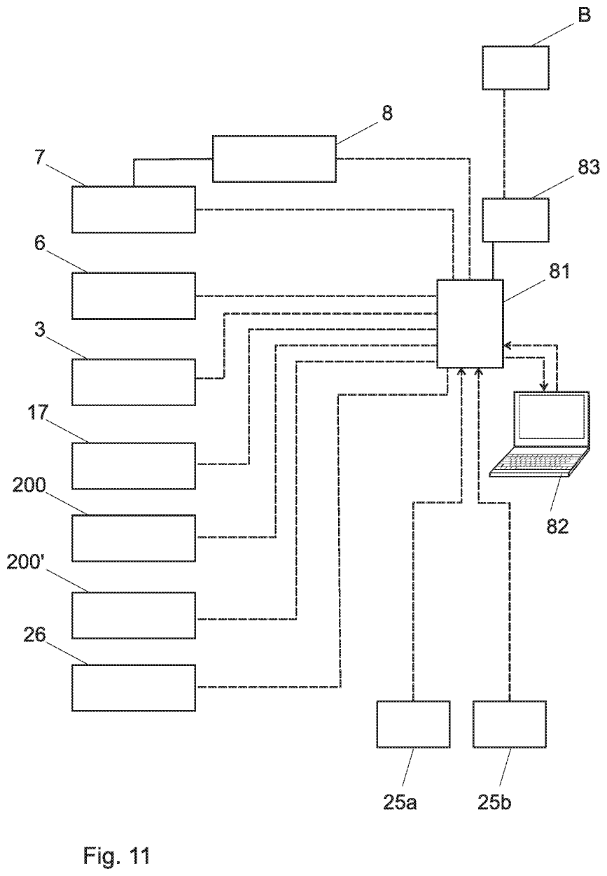

The patterning device 1 further comprises a control unit 81 adapted to pilot the functional elements of the patterning device 1 (FIG. 11). In particular, the control unit 81 is adapted to switch on or off the image recorder 7, the pattern generator 3, the light emitting system 6, and/or one or more injection devices 200, 200′. In addition, the control unit 81 is adapted to receive information from one or several sensors such as the vibration sensor 25b, the temperature sensor 25a, the image recorder 7, the levelling control means 17 and any other sensor. The control unit 81 pilots the above elements of the patterning device 1 according to a predetermined program or under instructions from the user. Any predetermined program or instructions from the user may be transmitted to the control unit 81 through a human machine interface (HMI) 82, such as a keyboard, a tactile screen or any other known human machine interface.

The control unit 81 may in addition by connected to the picture analyser 8 and receive from such a picture analyser 8 the images of the pattern appearing in the sample S under preparation. The control unit 81 may thus automatically recognize whether the pattern under preparation is conform to the expected pattern or not. The control unit 81 can then automatically pilot the elements of the patterning device 1 according to the images of the pattern under preparation. As an example, the control unit 81 may activate the pattern generator 3 according to a predetermined program, comprising a predetermined frequency or set of frequencies, a predetermined time duration, and a predetermined amplitude of the sound wave, while the picture recorder 7 allows to monitor the pattern formation. When the pattern is considered corresponding to a predetermined targeted pattern, the control unit 81 can activate a transformation device D such as the light emitting system 6 or a thermal management 26 to transform the matrix M of the sample S into a modified matrix M′, wherein the particles P are no longer able to migrate. Alternatively, the control unit 81 may be adapted to activate a transformation device D before the pattern is fully reached is such a way to limit or avoid the diffusion of the particles P in the matrix M once they reach the proper position. Alternatively, the control unit 81 may activate both pattern generator 3 and a transformation device D in order to allow the matrix M to be progressively transformed into a modified matrix M′ during the migration of the particles P.

According to an embodiment, the picture recorder 7 can be connected to the library B and store the pictures recorded, such as final patterns obtained at the end of series of steps including at least a patterning step and a transformation step. Such picture of pattern may be associated to several other parameters in the library B including the sound wave parameters such as the amplitude A and the frequency F, and the geometry of the container 46 in which the patterning was done.

Regarding the migration of the particles P in the sample S, the control unit 81 may activate a heat plate to increase the fluidity of the matrix M in case the migration of the particles P is judged too slow or inappropriate. Such matrix M remains non-transformed under the heating of the thermal management device 26, and can then be polymerised or crosslinked under UV irradiation once the particles P have reached the expected position.

The patterning device 1 can further comprise, or be connected to, an artificial intelligence module 83 (FIG. 11). Such an artificial intelligence module 83 may be used to automatically determine the suitable conditions to produce a predetermined pattern. It can further be used for the modelling of the patterns based on the pattern actually produced and stored in the library B.

According to an embodiment, the artificial intelligence module 83 can be used to determine the geometry of a sample container 46 according to the geometry of a pattern to be obtained.

The present invention further comprises a process of producing a three-dimensional structure based on particles P spread in a matrix M, as illustrated in FIGS. 12a and 12b. The process comprises a dispersion step Q1 wherein the particles P are homogeneously spread in a first layer L1 of a matrix M, which is fluid enough to allow an easy migration of the particles P. The dispersion step Q1 may involve a homogeniser or a movable table or any other mixing apparatus adapted for the homogenisation of the particles P in the matrix M. Alternatively, the dispersion step Q1 may involve the pattern generator 3, such as to produce vibrations allowing to homogenise the particles P in the matrix M. The dispersion step Q1 may be optional when the particles P are already homogeneously mixed with the matrix M.

The process may include a preliminary loading step Qa of loading a sample container 46 with a matrix M. The loading step Qa allows to fill a sample container 46 with a predetermined quantity of a predetermined matrix M. In case the matrix M already contains the requested particles P, the dispersion step Q1 may be optional. The loading step Qa may be followed by injection of additional material, even in case the particles P are already present in the matrix M. Such injection of additional material may be done manually or by means of one or more integrated injection device 200.

According to a preferred embodiment, the particles P are homogeneously or regularly dispersed in the matrix M, over the plane defined by the x and y axis. The particles P are in addition homogeneously or regularly dispersed in the matrix M over the thickness of the matrix M, meaning over the vertical axis z. In other words, no gradients of the particle concentration within the matrix M are expected before the sound wave patterning step is applied. More particularly, the viscosity of the matrix M is adapted to maintain the particles P homogeneously suspended in the matrix M, while allowing their migration under sound wave application. The particles P are thus not allowed to fall at the bottom of the sample container 46 before vibration waves are applied.

A patterning step Q2 is then applied in a way to migrate the particles P in the matrix M according to a predetermined pattern. The process comprises a transformation step Q3 wherein the matrix M is modified to a matrix M′, such as to prevent the migration of the particles P. Such a transformation step Q3 may be performed by means of a transformation device D of the patterning device 1 such as the light emitting system 6 or the thermal management device 26 or any other transformation device D the patterning device 1 comprises.

The dispersion step Q1, the pattering step Q2 and the transformation step Q3 may be performed sequentially, meaning that each of the necessary device such as the pattern generator 3 and the transformation device D are activated and inactivated one after the other. Alternatively, these steps may overlap or partly overlap each other, meaning that two or more of the pattern generators 3 and the transformation devices D can be concomitantly activated.

The process may further comprise a second dispersion step Q1′, wherein particles P2 are dispersed in a second layer L2 of a second matrix M2. The second dispersion step Q1′ may be performed in the same way as the first dispersion step Q1 or differently. The second dispersion step Q1′ may be optional in case the particles P2 are already homogeneously dispersed in the corresponding matrix M2 at the time the matrix M2 is placed with the sample S. The particles P2 may be identical or different from the particles P. The second matrix M2 may be identical, similar, or different from the matrix M. In particular the second matrix M2 may be transformed during the transformation step Q3′ under conditions different from the transformation step Q3 of the matrix M, such as a different transformation device D needs to be activated. For example, in case the transformation step Q3 of the matrix is done under light irradiation, the transformation step Q3′ of the second matrix M2 can be performed under heating. The reverse transformation steps Q3 and Q3′ can be applied.

According to an important aspect, several of the dispersion step Q1, the patterning step Q2 and the transformation step Q3 are performed without manipulating the sample container 46, meaning that the sample S remains in place during all the process or during a substantial part of the process. This is even the case when several layers L are built. This is also the case when the several layers L are sequentially built one on top of the other one.

The process may in addition comprise at least one step Q4 of injecting additional material on top or in the bulk of a layer without manipulating the sample container 46. Such injection may be performed manually. Preferably, the injection device 200 is used to this end. Such injection of additional material may be performed before or after the sound wave application. Alternatively, injection of additional material can be performed by means of the injection device 200 during the patterning of the sample S under sound wave application. It has to be understood that the injection device 200 can be used on demand at any time in the patterning process, in such a way that the sample S has not to be manipulated, and in such a way that concomitant actions can be applied to the sample S. For example, additional material may be injected to a given matrix M in a continuous way at one or more precise locations by means of the injection device 200, while waves are applied to the sample S.

The process according to the present disclosure results to a three-dimensional structure of particles within a matrix. In particular, the present process excludes removal of material such as the matrix surrounding the patterned particles.

The combination of the patterning technology and the injection of material, and in particular with the 3D-printing or additive manufacturing processes, allows to produce highly regular patterns comprising irregular or random particle distributions. Such arrangement is particularly advantageous for example for research tests or investigations.

The process may in addition comprise several steps of determining the geometry of a sample container 46 and printing on demand the sample container 46 having the determined geometry. Such 3D printing of non-biomaterial can be performed by means of an injection device 200′ integrated to the patterning device 1 or distinct from the patterning device 1. More particularly, the process can comprise a selection step a) wherein the geometry of a given sample container 46 is predetermined according to the targeted geometry of the pattern to be produced in a given layer L. The selection of the geometry of the sample container 46 considers several parameters such as the amplitude A and the frequency F of the sound waves W to be applied to a layer L wherein particles P are dispersed in a matrix M. In addition, the nature of the matrix M, or its composition, or at least its rheological properties can be considered since these parameters also influence the behavior of the particles P under sound wave exposure. The selection step a) can be performed based on previous sets of parameters B1 . . . Bm, stored in the library B. The selection step a) may in addition involve the artificial intelligence programs loaded in the artificial intelligence module 83, or in another artificial intelligence module, and educated for this purpose.

According to an aspect of the present disclosure, the artificial intelligence unit 83 allows to instantaneously analyse images of the patterned particles during the patterning process and compare such images to a predetermined targeted pattern. The artificial intelligence unit 83 thus allows to modulate or provide instructions to the control unit 81 so as to adapt the pattern generator accordingly until the desired pattern is obtained, either exactly or with a minimal acceptable deviation.

Once the geometry of a sample container 46 has been determined in the selection step a), the corresponding sample container 46 is produced. It is preferably produced on demand in a container production step b). The container production step b) advantageously uses the additive manufacturing technologies, and more particularly the injection device 200′ described above. Although the sample container 46 can be produced with any material adapted for the 3D-printing technology, such as polystyrene or related polymers, the sample container 46 is preferably made of biocompatible polymers such as polyvinyl alcohol or any other biocompatible polymers and mixtures thereof. In case crosslinking step is necessary, the chemical components and the polymerization conditions are selected to not damage the living material under preparation. The 3D printing process of the sample container 46 is for example performed at ambient temperatures or temperature below 40° C., preferably at a temperature comprised between around 20° C. and around 35° C. In case a UV crosslinking is performed, the light irradiation is preferably determined to not damage the living material under preparation.

A loading step Qa) as defined above allows to fill the sample container 46 with a matrix M and particles P.

The patterning step Q2) and the transformation step Q3) above described are then applied.

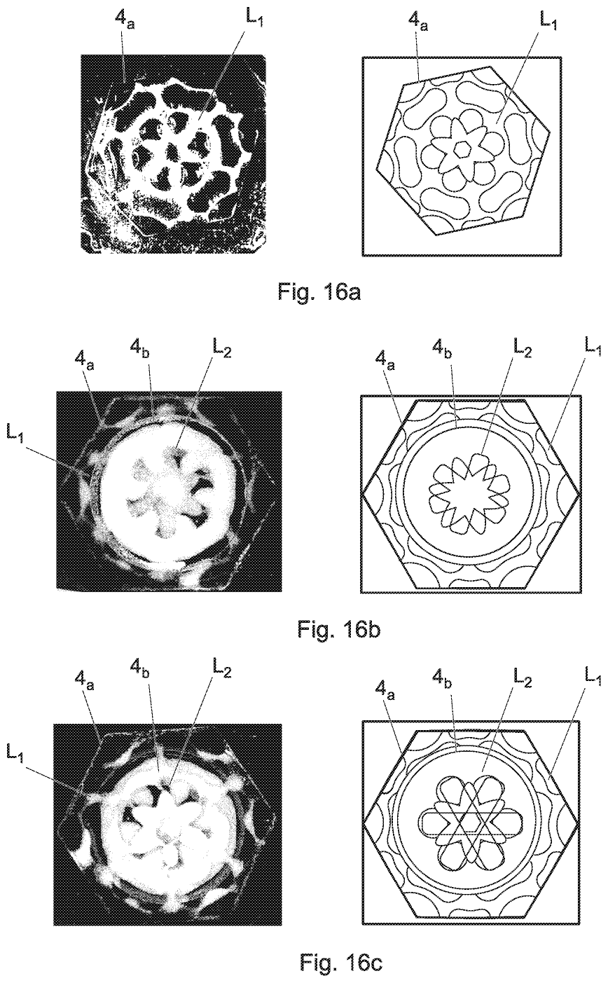

FIGS. 16a, 16b and 16c provide an example where a first sample container 4a having a hexagonal geometry is filled with a first matrix M1 comprising a first type of particles P1 to form a first layer L1 having a first pattern. FIG. 16b shows a second layer L2 having second pattern, produced based on a second sample container 4b, having round geometry. The second sample container 4b is placed on top of the first layer L1. FIG. 16c shows an alternative second pattern obtained on the basis of a round shaped second sample container 4b.

As an example, the patterns shown in FIGS. 16b and 16c where obtained as follows:
The matrix M was made of the hydrogel: Gelatin 70% methacryloyl (GeIMA 70%) 5% w/v photoresist (Irgacure).
   For the first layer L1, 800 μ1 were loaded into a squared frame;
   For the second layer: 400 μ1 were loaded into a circular frame;
The particles P were Tricalcium phosphate (TCP) with dimension comprised between 32 and 75 μm;
The vibration frequency was selected as follows:
   For the first layer L1: 78 Hz;
   For the second layer L2 (FIG. 16b): 60 Hz;
   For the second layer L2 (FIG. 16c): 65 Hz;
The vibration duration was selected as follows:
   Less than 10 seconds for the first layer L1 and less than 10 seconds for the second layer L2 after the liquid motility is reached by tuning frequency and amplitude;
The temperature was selected as follows:
   GeIMA temperature: 37° C.;
   Experimental temperature: room temperature (25° C.);
The transformation of the matrix M was performed as follows:
   Each layer of the sample was crosslinked in two steps:
   First, once the pattern is formed a mild UV-light was placed on top to stabilize the pattern through partial crosslinking;
   Second, the patterning chamber was then moved into a UV-light oven for complete the crosslinking of the hydrogel.
   The crosslinking process took place at room temperature (25° C.) with a UV-light wavelength of 365 nm.

The process described above allows to produce several layers (Ln) wherein “n” denotes an integer comprised between 1 and 50, preferably between 2 and 10. According to one embodiment, the different layers L1 to Ln are produced in parallel or sequentially in an individual manner, meaning that each layer L1 to Ln is produced independently from the other ones, as shown for example in FIG. 15. In case of a parallel production, several sample containers 4a to 4e are exposed to sound waves W1 to Wn originating from several independent pattern generators S1 to Sn. The geometry of each of the sample containers 4a to 4n as well as the characteristics of the sound waves W1 to Wn are individually determined and may differ from one sample container 4n to the other one. Once the layers Ln are produced, they can be combined to make the expected three-dimensional structure.

According to another embodiment, the layers L1 to Ln are sequentially made and combined, meaning that once a given layer Ln is produced, the following layer Ln+1 is produced above the preceding layer Ln. In other words, after a pattern has been produced in a sample container 4n, the container 4n+1 of the next rank n+1 is placed on the top of the previous layer Ln. It has the geometry adequate for this expected new pattern. This new sample container 4n+1 is then filled with the corresponding particles Pn+1 dispersed in the suitable matrix Mn+1, and the experimental conditions, comprising the sound wave amplitude An+1 and frequency Fn+1, are applied to produce the requested pattern. The polymerization of the matrix Mn+1 is then performed under the suitable transformation conditions. When this approach is followed, the sound waves are applied to the combination of the sample containers 4a to 4n related to the layers L1 to Ln already prepared in addition to the layer Ln+1 under preparation. The particles Pn should remain immobilized in the previously modified matrices Mn of these produced layers Ln.

A recording step f) may occur at the end of each producing cycle, a producing cycle comprising the selection step a), the frame production step b), the filling step c), the patterning step d) and the transformation step e) above described. In case the layers L1 to Ln are sequentially made on top one of another, the monitoring steps may be used to monitor the layers already built and verify whether they have not be damaged under the iterative conditions of the process.

When all the layers L1 to Ln are produced and stacked, the process may include an incubation step g) wherein the living material of the three-dimensional structure is allowed to grow to produce the expected biological tissue.
1 Patterning device
10 Damping devices
10a, 10b Silent block
11 foot
12a, 12b Rotatable connector
13 Guide
14 Locker
15 Support
16 Counterweight
17 levelling control means
2 Holder
21 Holder plate
22 Holder connection means
23a, 23b Adaptor connection means
24 Container adaptor
25a, 25b Sensors
26 Thermal management device
3 Pattern generator
31 Generator connection means
32 Vibration generators
4 Container fixation means
41 Base
42 Removable cap
43 Cap clamping arrangement
44 Sealing
45, 45a, 45b, 45c Cap adaptor
46, 4a, 4b, 4c, 4d Sample containers
48a, Individual dish
48b wellplate
5 Intermediate connector
51, 51a, 51b Lateral damping device
6 Light emitting system
61 Emitting lights
62 Light frame
63 Hole
7 Picture recorder
8 Picture analyser
9 Frame
81 Control unit
82 Human Machine interface
83 Artificial intelligence module
100 Container positioning means
100a First positioning element
100b Second positioning element
101 Intermediate element
200 Bio-injection device
200′ Injection device for non-biological material
D Device for the chemical transformation of the sample
L, L1, L2 Layers
P Particles
M Matrix
S Sample

1. A patterning device for the preparation of three-dimensional structures of a sample comprising particles free to migrate in a matrix, the patterning device comprising a pattern generator, comprising at least one vibration generator or set of vibration generator allowing to apply sound or other vibrational waves to the sample, a holder connected to the pattern generator and adapted to hold a sample container comprising the sample, wherein the patterning device further comprises at least one transformation device adapted for the transformation of the matrix into a modified matrix wherein the particles are no longer free to migrate, while remaining non-linked to each other and arranged according to a pattern, a control unit adapted for controlling one or more of the pattern generator and at least one transformation device, and a picture recorder.

2. Device according to claim 1, wherein the at least one transformation device is a light emitting system or a thermal management device or a combination of a light emitting system and a thermal management device.

3. (canceled)

4. Device according to claim 2, wherein the at least one transformation device can be used concomitantly or sequentially to the pattern generator.

5. Device according to claim 1, wherein the holder comprises at least one of a temperature sensor and a vibration sensor.

6. Device according to claim 1, wherein said patterning device comprises one or more lateral damping means.

7. (canceled)

8. Device according to claim 71, wherein said control unit comprises or is connected to an artificial intelligence unit.

9. Device according to claim 1, further comprising an illumination system allowing to visualize and record the pattern of the sample.

10. (canceled)

11. Device according to claim 10, wherein the at least one vibration generator or set of vibration generators emits waves from positions lateral to the sample.

12. (canceled)

13. Device according to claim 1, further comprising at least one injection device adapted for the 3D-bio-injection of biomaterial.

14. (canceled)

15. A set comprising several accessories including two or more different emitting lights or groups of lights, two or more different picture recorders 7, two or more different holders.

16. A process for producing a three-dimensional structure of particles in a sample comprising particles free to migrate in a layer of a matrix, comprising a patterning step of arranging the particles in said layer under application of sound waves to the sample such as to reach a predetermined pattern, and a transformation step of modifying the matrix into a modified matrix wherein the particles are no longer free to migrate, wherein the patterning step and the transformation step are performed by means of a control unit without handling the sample.

17. Process according to claim 11, further comprising second patterning step of arranging second particles in a second layer of a second matrix under application of sound waves to the sample in order to create a second predetermined pattern, and a second transformation step of modifying the second matrix into a modified second matrix wherein the second particles are no longer free to migrate, wherein the second layer is on top of the layer.

18. Process according to claim 16, further comprising one or more injection steps of injecting additional material in, or on top of, one or the other layers, wherein said one or more injection steps are performed by means of an injection device integrated or combined to the patterning device.

19. Process according to claim 11, further comprising one or more container production step, wherein one or more sample container are printed on demand by means of an injection device.

20. Process according to claim 14, wherein said sample container has a geometry predetermined according to the geometry of the targeted pattern.

21. Sample having a three-dimensional structure, wherein said sample is printed under sound waves according to the process of claim 11, using a patterning device according to claim 1.
